(19) United States
(12) Patent Application Publication
(10) Pub. No.: US 2007/0079535 A1
(43) Pub. Date: Apr. 12, 2007

(54) Roadside memorial marker

(76) Inventor: Scott Kevin Newton, Lakewood, CO (US)

Correspondence Address: LEYENDECKER LEMIRE & DALEY, LLC, C/O PORTFOLIO IP, P.O. BOX 52050, MINNEAPOLIS, MN, 55402, US

(21) Appl. No.: 11/247,692

(22) Filed: Oct. 11, 2005

(51) Int. Cl. G09F 1/10

(52) U.S. Cl. 40/124

(57) ABSTRACT

A semi-permanent to permanent roadside memorial marker is described. In certain embodiments, the marker comprises ornamental iron (or steel) stock that is welded together to form a memorial marker, such as a cross. A auger-type anchor, typically made of steel, is weldably attached to the bottom end of the memorial to firmly secure it into the ground surface proximate a roadside. In some embodiments an illuminator can be provided to make the memorial visible to passing nighttime drivers.

### FIELD OF THE INVENTION

This invention pertains to memorial markers.

### BACKGROUND

In the United States, it is common for loved ones of a person that has died in an automotive accident to place a memorial along the side of the road where the fatal accident took place. Often these memorial markers are crudely and quickly constructed and after a relatively short period of time can become dilapidated and an eyesore. Often these memorials, which typically comprise crosses, are simply driven into the ground that work themselves loose over a relatively short period of time and fall over.

Local government officials have conflicting views of these roadside memorial. On one hand, the memorials often require cleanup and/or maintenance by road crews and as such put additional strain on limited governmental resources. On the other hand, these memorials serve as solemn reminders to the public of the potential dangers of driving. In this regard, they remind drivers to slow down, drive less recklessly, and not to drink and drive. Ultimately, the public value of the memorials out weigh the maintenance issues related to them. Nonetheless, memorials that are longer lasting and require less attention are desirable.

### BRIEF DESCRIPTION OF THE DRAWINGS

FIG. 1 is an isometric view of a roadside memorial installed along a roadside according to one embodiment of the present invention.

FIG. 2 is an isometric view of a memorial cross according to one embodiment of the present invention.

FIG. 3 is an isometric view of a memorial cross according to another embodiment of the present invention.

FIG. 4 is an isometric view of a memorial cross according to yet another embodiment of the present invention.

FIG. 5 is a block diagram illustrating the circuitry of an illuminator used in embodiments of the present invention.

FIG. 6 is a flow chart illustrating a process for manufacturing a memorial according to one embodiment of the present invention.

FIG. 7 is a flow chart illustrating a process for erecting a memorial along a roadside.

### DETAILED DESCRIPTION

According to one embodiment a semi-permanent to permanent roadside memorial is described. Preferably, the roadside memorial comprises a material that will not degrade appreciably if exposed for periods to weather and has the strength to withstand wind, sun, rain and snow without breaking or deforming. In one variation, memorial is comprised of ornamental iron of the same general type that is used on gates and wrought iron fences. Additionally, the material can be painted to beautify the memorial and provide additional protection from the elements.

To attach the roadside memorial an auger (or screw) type anchor is coupled to the bottom of the memorial. Once this type of anchor is inserted into the ground, it is very difficult to remove other than be rotateably backing it out. Accordingly, unlike staked memorials, embodiments of the present invention will not loosen appreciably over time as the cars are buffeted by wind from passing cars and splashed with rain and snow. In at least some variations, the anchor is welded or otherwise permanently attached to the memorial, such someone installing the memorial need only twist the memorial to screw the anchor into the ground. When the memorial comprises a cross, the arms of the cross provide the installer with convenient places to grab the memorial and twist the anchor into the ground.

In other variations and embodiments, the memorial includes ornamental distributed on and over the memorial to beautify the memorial. The ornamentation is not limited to any particular depiction or item but may typically comprise; leaves, vines, flowers, angels, and other religious symbols. In embodiments comprising iron or steel, the ornamentation may also be comprised of steel or iron and be welded to the memorial. The ornamentation may also be painted the same or different colors than the remainder of the memorial.

In yet other variations and embodiments, a memorial is illuminated by fiber optic fibers that extend from an illuminator and terminate a distal ends that are distributed over and on the memorial. Accordingly, the ends of the fibers form dimly lit points of light that do not distract a night time driver but when combined with the many other points of light make the shape of the memorial visible to the passing driver. In some variations, the distal ends of the fibers are secured to the memorial structure in such a manner that they can move back and forth when subjected to a breeze causing the plurality of points of light to appear as through they are twinkling.

Terminology

The term “or” as used in this specification and the appended claims is not meant to be exclusive rather the term is inclusive meaning “either or both”.

References in the specification to “one embodiment”, “an embodiment”, “a preferred embodiment”, “an alternative embodiment”, “embodiments”, “variations”, “a variation” and similar phrases means that a particular feature, structure, or characteristic described in connection with the embodiment(s) or variation(s) is included in at least an embodiment or variation of the invention. The appearances of the phrase “in one embodiment” or “in one variation” in various places in the specification are not necessarily all referring to the same embodiment or variation.

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiments and are not necessarily intended to be construed as limiting.

The term “coupled” refers to two or more elements that are connected together but not necessarily directly connected together.

As applicable, the terms “about” or “generally” as used herein unless otherwise indicated means a margin of +−20%. Also, as applicable, the term substantially as used herein unless otherwise indicated means a margin of +−10%. It is to be appreciated that not all uses of the above terms are quantifiable such that the referenced ranges can be applied.

As used herein the phrase “auger-type anchor” and similar variations thereof refers to any type of anchor that is secured into the ground by screwing the securing portion of the anchor into the ground as opposed to being pressed axially into the ground, such as with a stake. Two different types of augar-type anchors are illustrated herein: one comprises a shaft with a generally helical ribbon that radiates from and rotates about the shaft; and the other comprises a spirally wrapped (or corkscrew) wire form. Other variations of auger-type anchors that meet within the definition above are also contemplated.

The phrase “ornamental iron stock” as used herein refers specifically to iron or steel bar stock and other ornamental pieces of iron or steel used to make or salvaged from iron (or steel) fences, gates, and security doors; as well as, other iron or steel non-ornamental pieces that, although not traditionally used for ornamentation, can be. The bar stock can be decorated with ornamental features or can be plain. The bar stock can have any suitable cross sectional shape including but not limited to circular, or polygonal. The non-ornamental pieces can for example include iron rings and horse shoes.

The term “illuminators” or “illuminator” as used herein refers to any source of light suitable for providing light for or in relation to a memorial. An illuminator typically comprises an electrically powered light but can also comprise illuminescent glow-in-the-dark materials. When an electric illuminator is used, the “light bulb” can comprise a standard incandescent bulb, a fluorescent bulb, one or more LEDs, or a bulb of any other suitable configuration. The electric illuminator is typically powered by batteries but AC current can also be utilized in variations. In other variations, one or more capacitors could be used to provide power. One or more solar cells may be provided to recharge the batteries or capacitors during the day.

One Embodiment Memorial

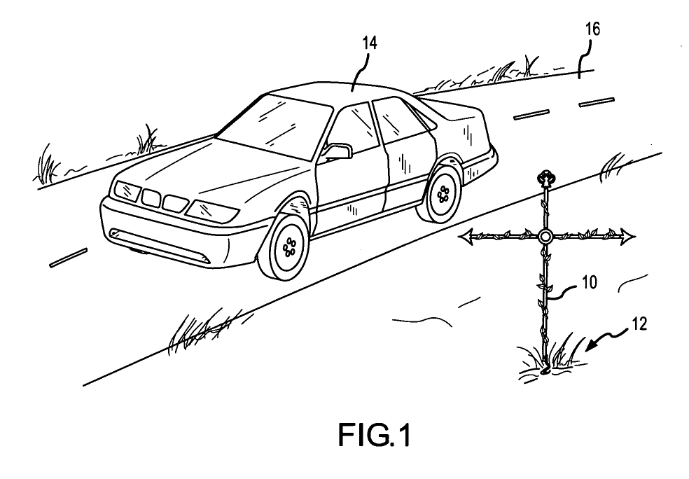

Referring to FIG. 1, one preferred application of a memorial according to embodiments of the present invention is illustrated. Simply, the memorial 10, which as illustrated comprises a cross, is installed on the side 12 of a road 16 typically proximate a location where person(s) lost there lives in a car accident. Accordingly, the cross is viewable by people in vehicles 14 that pass by the cross and serves as a sobering reminder of the deadly potential of automobiles when not operated with the appropriate levels of respect and caution. It is to be appreciated that the memorial can comprise any suitable symbol and is not limited to a cross. For instance, if the person who is being memorialized was Jewish, the memorial may comprise a Star of David.

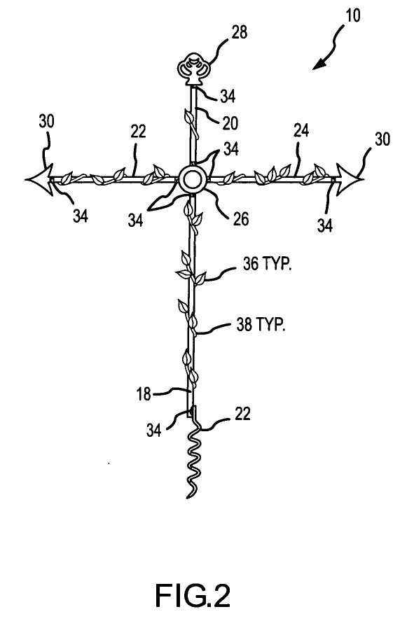

A first embodiment memorial cross 10 is illustrated in FIG. 2 and is comprised substantially of ornamental iron stock. The cross includes two generally vertically-orientated iron bar stock leg members 18 & 20 that are coupled to each other by way of an iron ring 26 to which each leg is welded 34. A pair of generally horizontally-orientated arm members 22 & 24 are also welded to the ring forming the general shape of the cross in conjunction with the leg members.

While the illustrated cross includes a ring at the intersection of the arm and leg members, in variations the center ring can be eliminated such that the arm members directly intersect with the leg members. Further, one or both of the leg and arm members can comprise a single piece of bar stock instead of two pieces as shown.

Referring back to FIG. 1, the top end of the upper leg member 20 includes a decorative finial 28 that is joined to the leg member by way of a welded joint 34. The actual design of the finial is a matter of choice and can comprise any number of designs. For instance, a finial depicting one or more cherubs might be suitable if the person for whom the memorial is intended was a child. In other variations, the finial could comprise a depiction of an angel. Most typically, however, the finial, if used, will be of a design and configuration similar to those commonly used on iron gates and fences.

Decorative end caps 30 are weldably attached to the distal ends of the arm members 22 & 24. Of course, the form and design of the end caps can vary depending on the desires of the person creating the cross. It is appreciated that while the finials and end caps are often comprised of iron or steel and joined to the cross 10 by way of weldedjoints 34, in variations one or more of the finials and end caps can be comprised of other materials, such as but not limited to plastic, and can be attached to the cross by any suitable means, such as mechanical fastening, brazing and adhesive bonding.

To further decorate this embodiment of a memorial cross, vine stalks 38 and associated leaves 36 are distributed over the leg and arm members 18-24. The leaves and stalks are typically comprised of iron (or steel) and are welded to the arm and leg members, although in variations, the stalks and leaves can comprise any suitable material and be joined to the cross by any suitable means. In yet other variations, the design and configuration of the ornamental pieces attached to the arm and leg members can take any suitable form. For instance, the pieces can include flowers, angles, cherubs and religious symbols to name a few.

To protect the iron cross memorial 10 from the elements, it is typically painted. The entirety of the cross can be painted a single color, or it can be painted any number of colors and color combinations. In the illustrated embodiment, the leaves are typically painted green while the remainder of the cross is painted white.

To install the cross in the ground along the side of a road, an auger-type anchor 32 is provided. Specifically, the anchor illustrated comprises a cork screw wire form that digs into the ground as it is rotated. The anchor is typically comprised of steel and is welded to a base end of the lower leg member 18. In variations, the anchor can be attached to the cross using other suitable means, such as mechanical fastening. Typically, the anchor is firmly and securely attached to the cross to permit an installer to install the cross into a ground surface by holding the cross at each arm member 22 & 24 and rotating the cross to cause the anchor to dig into the ground. However, in certain variations, the anchor can be installed into the ground first and then the cross is mechanically fastened to the portion of the anchor that remains above the ground.

Another Embodiment Memorial

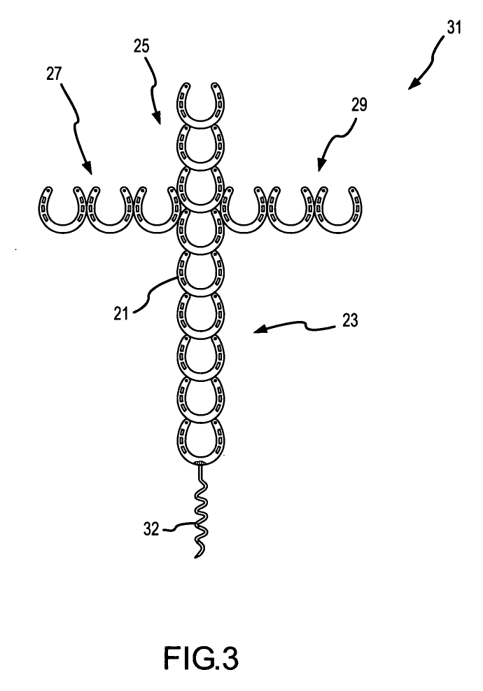

Referring to FIG. 3, another embodiment of a memorial cross is illustrated. The cross comprises a plurality of horse shoe pieces 21 that are welded together to for the arm members 27 & 29 and the leg members 23 & 25. In other variations, other types of pieces of iron or steel stock can be welded together to form arm and leg members and ultimately a memorial cross. For example, a cross or other symbol could be fabricated from a plurality of iron rings. Also, combinations of various different pieces can be welded together.

Similarly, to the embodiment of FIG. 2, an auger-type anchor is attached to a base end of the lower leg member 23. As shown, the anchor is welded to the lower most horse shoe 21 of the lower leg member. Further, like the embodiment of FIG. 2, the embodiment of FIG. 3 is typically painted to protect it from the weather.

An Embodiment of an Illuminated Memorial

Referring to 4, an illuminated memorial cross embodiment is illustrated. The cross is typically comprised of iron (or steel) ornamental bar stock. As shown, the cross comprises a single leg member 42 and two arm members 44 that intersect with and are joined to the leg member at respective welded joints 52. In variations, a single arm member can replace the two arm members and be weldably secured to the leg member at their common intersection. Further in another variation, the cross can comprise a single arm member and both upper and lower leg members.

As illustrated, an angel finial 46 is attached to the top end of the leg member by way of a welded joint 52. Further, end caps 48 are provided at the respective left and right ends of the left and right arm members 44 to which they are typically welded. Further, like the other embodiments, an auger-type anchor 50 is attached to the bottom end of the leg member 42. The anchor illustrated is of a second type comprising a shaft with a generally helical ribbon that radiates from and rotates about the shaft. It appreciated that either type of anchor can be used on any type of memorial embodiment. As illustrated the anchor is welded to the leg member via a weld joint 52.

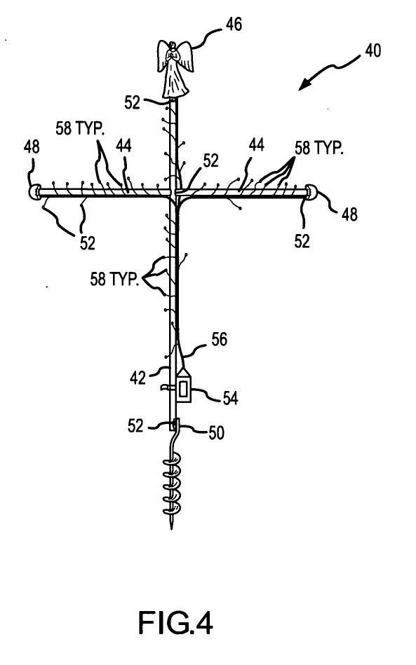

Distinctive of the other embodiments, this embodiment incorporates a lighting system to make the cross visible at night. As shown in FIG. 4 the illuminator 54 is typically attached to the leg member near its base end just above the anchor. However, in variations the illuminator can be attached to the memorial at any suitable location. The means of attachment can vary from a clamp to mechanical fasteners to adhesive bonding. Typically, the illuminator comprises a water tight plastic or metal enclosure to isolate the electronic components and the power source from the weather.

A fiber optic cable 56 comprising a relatively large number of fiber optic fibers is coupled to the box wherein the proximal ends of the fibers are facing the illuminator's light source. The cable is attached to the leg member and extends upwardly there along. The cable can be attached to the leg member by any suitable means including adhesive bonding or mechanical fastening. Periodically along its length individual or small bundles of fibers are separated from the cable and distributed over the leg member such that the distal ends 58 of the fibers are exposed to transmit light from the illuminator. The individual fibers can be adhesively or otherwise fastened to the leg member at the various locations. In one variation, the fibers are each attached to the leg member (or the arm members) at a point along the fiber inwardly of the fiber's distal end. Accordingly, the relatively thin fiber is free to move back and forth a short distance when subjected to wind or a breeze.

At the intersection of the leg and arm members, the cable is split into three partial bundles of fibers with the first set extending upwardly towards the finial 46 and the remaining two bundles extending leftwardly and rightwardly along the respective left and right arm members 44. Fibers are separated from the partial bundles and distributed over the upper section of the leg and both arm members.

FIG. 5 is a block diagram of a typical illuminator that can be used in embodiments of the present invention. A controller 56 can be provided to control and regulate the light source, which in preferred variations comprises light emitting diodes 66 (LEDs). A power source is provided that typically comprises batteries 60. It is appreciated that ultra bright LEDs are extremely energy efficient when compared to traditional incandescent bulb and as such can run for extended period of time on a battery pack would have been considered only 10 years ago to be rather small. To charge the batteries during the day, one or more photovoltaic cells 62 can also be provided. The controller would control the charging of the batteries by the cells to minimize the risk of over charging and to help maximize the effective life of the power supply. In some variations, a day/night sensor 64 can be provided to signal the controller to turn off the lights when the sun is up. In other variations with solar cells the controller can make a determination on whether it is nighttime or daytime based on the amount of current being generated by the cells. Given that traffic on public roads drops off drastically in the heart of the night, the controller may also incorporate a timer (or clock) circuit 58 that automatically shuts off the illuminator after a certain period of time has passed since it was activated. This was battery power can be saved from people are unlikely to see the memorial due to lack of traffic on the associated road. It is to be appreciated that the controller can be extremely simple and have little or no logic functions or can be relatively complex depending on the memorial embodiment as would be obvious to one of ordinary skill in the art to which this invention pertains.

A Method of Making a Memorial

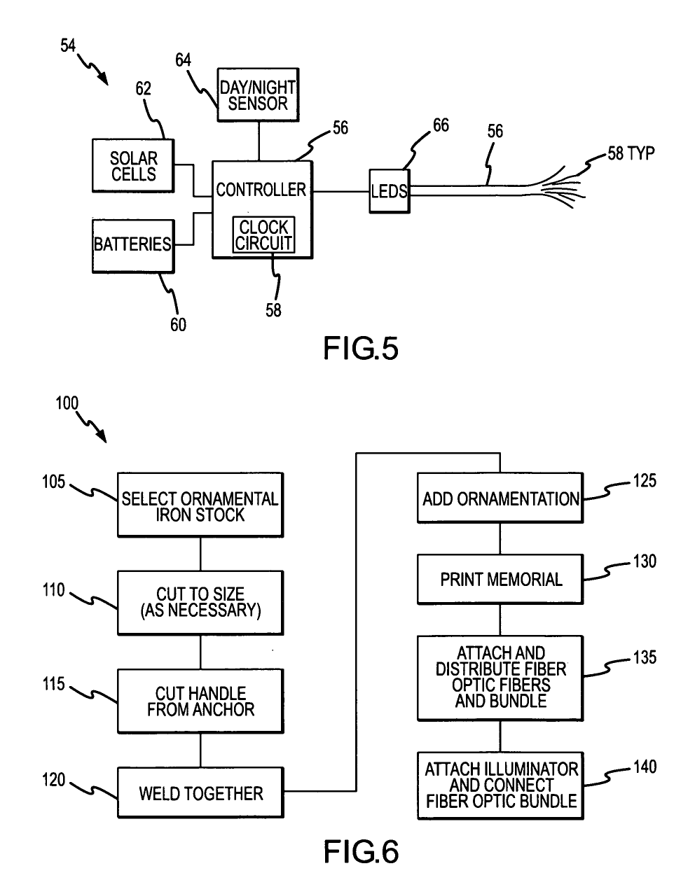

Referring to the block diagram 100 of FIG. 6, a method of making an embodiment of a memorial marker is described herein. Initially as shown in block 105, the fabricator selects iron ornamental stock for which to fabricate the memorial. The iron stock can be chosen to represent certain aspects of the person being memorialized or the stock can be chosen based on other criteria. Steel part, pieces and bar stock can be used in place of or which the iron stock. Next, as shown in block 110, the pieces and bar stock are cut to size as is necessary to fabricate a memorial of the desired dimensions.

Referring to block 115, the anchor is prepared for welding to a leg member. In certain embodiments, the anchor comprises a cork screw wire form of the size and dimensions often used to anchor dog run leads into the ground. A dog run anchor, however, has a handle on its top end. This top end is cutoff and discarded.

Next, as indicated in block 120, the memorial is welded or otherwise joined together including the auger-style anchor. Ornamental pieces are added, as necessary or desired, to the cross. Typically the ornamental pieces including finials and end caps are comprised of iron or steel and accordingly, are welded in place. However, in some variations, some or all of the ornamental pieces can comprise other materials and as such are attached using other processes such as but not limited to adhesive bonding.

After all the pieces have been added to the memorial, the memorial is painted as shown in block 130. Typically this comprises spray painting the entire memorial a base color, such as white, and then individually painting any ornamentation as desired.

For those embodiments incorporating illumination as shown in block 135, the fiber optic bundle and fibers are attached to the memorial with the distal ends of the fibers being distributed over the surface of the memorial. Finally, the illuminator is coupled to the memorial and the fiber optic bundle is coupled to the illuminator as indicated in block 140.

A Method of Installing a Memorial

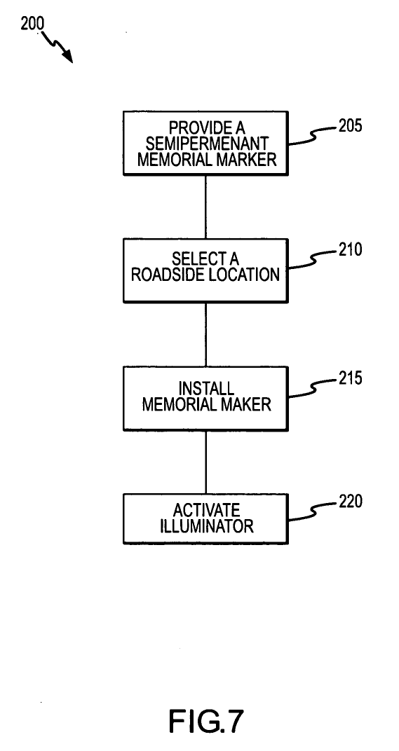

Referring to the block diagram 200 of FIG. 7, a method of installing a semi-permanent or permanent memorial marker is described herein. First, a suitable memorial marker must be obtained as indicated in block 205. Preferably, the marker is comprised of a weather resistant material that can withstand years of exposure. Also, the memorial should include an auger-type anchor for firmly and securely attaching the marker to the ground.

Next, a suitable location for the marker must be chosen as indicated in block 210. Obviously, the location is preferably located near the seen of the accident that took the life of the person being memorialized. The location should not be so close to the road that it could hinder the operation of automobiles. For instance, the memorial marker probably should not be located on a shoulder on which automobiles can pull on to. Conversely, the marker should not be located so far from the road as to not be visible to passing motorists. The person installing the memorial must also consider who owns the land on which the cross is being placed. If the property along the side of the road is private, the installer may want to consider obtaining permission. Further, the installer may want to check with the local law enforcement or governmental authorities to determine whether ordinances or laws exist that regulate or even prohibit the placing of roadside markers.

Once a location has been chosen, the installer can install the memorial marker as indicated in block 215. In the embodiments described above, the anchor is permanently attached to the memorial marker. Accordingly, the entire marker must be rotated to drive the anchor into the ground. In the case of cross memorial markers, the arms of the cross provide convenient locations for an installer to grab with his her hands and rotate the marker and associated anchor while applying a downwardly pressure. The length of the arms also provides for significant leverage and mechanical advantage making the installation easier then installing, for instance, a dog run anchor of a similar configuration.

Finally, as indicated in block 220, the installer activates the illuminator as applicable. More advanced illuminators with more complex controllers may provide the installer with the ability to set the times that the memorial illuminates and the time at which the lights are turned off. More commonly, however, the illuminator will have a day/night sensor or an equivalent to trigger the turning on and off of the lights. In other more simple variations of the illuminator, it will remain on constantly, although the illumination will likely not be noticeable during daylight hours.

Alternative Embodiments and other Variations

The various preferred embodiments and variations thereof illustrated in the accompanying figures and/or described above are merely exemplary and are not meant to limit the scope of the invention. It is to be appreciated that numerous variations to the invention have been contemplated as would be obvious to one of ordinary skill in the art with the benefit of this disclosure. All variations of the invention that read upon the appended claims are intended and contemplated to be within the scope of the invention.

For instance, the memorial markers can be made of materials other than iron or steel. In one variation the marker can be aluminum with the anchor also being aluminum that is welded to the marker. In other variations, the anchor can be steel and adapted to mechanically fasten to the aluminum memorial marker. The memorial can also be comprised of a weather resistant plastic material wherein the anchor is mechanically fastened to the marker. In the instances wherein the anchor is mechanically fastened, an installer may install the anchor into the ground by itself and subsequently attach the memorial marker thereto.

In other embodiments and variations, the tubular members can be used for the legs and the arms. Accordingly the fiber optic bundles can be snaked through the interior of the memorial and the individual fibers can emanate from the interior by way of small holes drilled into the tubing at desired locations over the surface of the memorial. If the diameter of the tubing is sufficient, the illuminator itself can be enclosed in the interior of the memorial marker. In some variations, individual LEDs or other small illumination sources can be distributed over the surface of the memorial in place of the fiber optic fibers. In yet other variations, a combination of LEDs and fiber optic fibers could be used. In yet other embodiments, electric sources of illumination can be dispensed with entirely and illuminescent glow-in-the-dark material can placed at desired locations on the memorial.

I claim:

1. A memorial cross comprising:
one or more generally vertical leg members;
one or more generally horizontal arm members weldably coupled to the leg members to form a cross; and
an auger type anchor coupled to a proximal end of a leg member of the one or more generally vertical leg members.

2. The memorial cross of claim 1, wherein the auger-type anchor is welded to a base end of the leg member.

3. The memorial cross of claim 1, wherein the leg and arm members comprise one or both of steel and iron.

4. The memorial cross of claim 1, wherein the leg members and the arm members comprise ornamental iron bar stock.

5. The memorial cross of claim 1, wherein at least one of the arm and leg members comprise a plurality of steel or iron pieces that are welded together.

6. The memorial cross of claim 1, further comprising one or more illuminators and at least one associated power source.

7. The memorial cross of claim 6, further comprising a plurality of fiber optic fibers, each fiber having a proximal end and a distal end, wherein (i) the proximal end of each fiber optic fiber is located proximate at least one illuminator of the one or more illuminators, and (ii) the distal ends of the plurality of fiber optic fibers are distributed over the arm and leg members.

7. The memorial cross of claim 7, wherein the one or more illuminators comprises one or more LED lamps and the associated power source comprises one or more batteries.

9. The memorial cross of claim 6, wherein the at least one associated power source comprises one or more batteries and one or more solar cells.

10. The memorial cross of claim 2, further including iron or steel ornamentation distributed on one or both the arm and leg members, the ornamentation comprising one or more from the set including flowers, leaves, vines, angles, cherubs, and religious symbols.

11. The memorial cross of claim 2, wherein one or more distal ends of the arm and leg members include one or more finials mounted thereon.

12. The memorial cross of claim 11, wherein the one or more finials comprise one or both of steel and iron.

13. A method of making a roadside memorial, the method comprising:
welding together pieces of ornamental iron stock to form a symbol; and
welding an auger-type anchor to a base end of the symbol.

14. The method of claim 13, further comprising cutting an integral handle off of an end the auger-type anchor prior to welding the anchor to the symbol.

15. The method of claim 13, further comprising attaching finials and ornamentation to the symbol by welding.

16. The method of claim 13, wherein the symbol is one of a cross and the Star of David.

17. The method of claim 13, further comprising attaching a plurality of fiber optic fibers to the symbol wherein the distal ends of the fiber optic fibers are distributed over the symbol.

18. A method comprising:
providing a memorial cross comprised of (i) generally vertical leg members, (ii) generally horizontal arm members weldably coupled to the leg members to form a cross, and (iii) an auger type anchor coupled to a base end of one leg member;
selecting a location of ground to erect the memorial cross proximate the side of a road;
holding the cross in one's hands; and
securing the cross in the ground by rotating the cross while applying downwardly pressure there to cause the auger-type anchor to penetrate the ground and secure the cross in an upright position.

19. The method of claim 17, wherein the anchor is weldably coupled to the base end.

20. The method of claim 17, wherein the memorial cross further includes an illuminator and a plurality of fiber optic fibers coupled with the illuminator at their proximal ends, and wherein the method further comprises activating the illuminator.
